(19) United States
(12) Patent Application Publication
(10) Pub. No.: US 2015/0342815 A1
(43) Pub. Date: Dec. 3, 2015

(54) WALL MOUNT MASSAGER

(71) Applicants: Kevin Lewis Watson, Edmonton (CA); Marcia Lynn Watson, Edmonton (CA)

(72) Inventors: Kevin Lewis Watson, Edmonton (CA); Marcia Lynn Watson, Edmonton (CA)

(21) Appl. No.: 14/291,587

(22) Filed: May 30, 2014

(51) Int. Cl. A61H 1/00

(52) U.S. Cl. CPC A61H 1/001

(57) ABSTRACT

The present invention relates to massage assembly structured for mounting on a vertical supporting surface during a massaging procedure. The massage assembly includes an elongated housing mounted on the supporting surface in a substantially vertical orientation. A contact assembly is movably disposed on the housing and is operative to apply a massaging pressure to predetermined body portions of the user. A sensor assembly is disposed and structured to determine at least one area of engagement between the housing and the user's body. A drive assembly is connected in driving relation to the contact assembly. The sensor assembly is connected to the drive assembly and is operative to determine at least one area of application of the contact assembly on the predetermined body portion.

### BACKGROUND OF THE INVENTION

1. Field of the Invention

The present invention relates to massage assembly structured for mounting on a vertical supporting surface during a massaging procedure.

2. Description of the Related Art

The importance of postural exercises in decreasing posture-related pain syndromes is well recognized. Further, with the widespread acceptance and use of mobile devices, tablets, and other electronic devices, a new phenomenon known as “text neck” has been recognized. Text neck results from an individual spending an inordinate amount of time in a forward head posture, as commonly results from texting, as well as use of now prevalent mobile devices and computers. In addition, studies have shown that for every inch of forward head carriage, 15-30 pounds of stress is placed on the upper back. As a result, those with poor posture typically suffer from rolled shoulders, tight back and neck muscles, spinal pain, and instability resulting from chronic overuse of computers, tablets and smart phones. Other studies have shown an increased risk of mortality in those with a forward head posture as well as “hyperkyphosis,” colloquially known as a “hump back” posture. A study by the American Geriatrics Society reported that people with hyperkyphosis had 1.44 times the mortality rate than those with proper posture. In addition, 80% of North Americans are estimated to be afflicted with back pain at some point in their lives.

Attempts to address these concerns have been made in the form of robotic massage chairs, which have grown into a multi-billion dollar industry. In fact, it has been estimated that as many as 1 in 5 homes in Japan has at least one robotic massage chair. However, robotic massage chairs are expensive and extremely bulky, occupying a significant amount of space. Furthermore, sitting in a chair does not require use of any postural or core muscles.

Therefore, what is needed in the art is a massage assembly that can be mounted unobtrusively, such as in a home or office. Such an assembly may facilitate a user's strengthening of postural and/or core muscles through their exercise, additionally addressing the root cause of the problem. In so doing, a user of such an assembly may be viewed as being proactive. In addition, the massage assembly may be structured to provide a massage as a reward for performance of postural and/or core muscle exercises.

### SUMMARY OF THE INVENTION

The present invention relates to massage assembly structured to be mounted on a vertical supporting surface during a massaging procedure. The massage assembly comprises an elongated housing mounted on the supporting surface in a substantially vertical orientation. A contact assembly is movably disposed on the housing and is operative to apply a massaging pressure to predetermined body portions of the user. A sensor assembly is disposed and structured to determine at least one area of engagement between the housing and the user's body. A drive assembly is connected in driving relation to the contact assembly. The sensor assembly is connected to the drive assembly and is operative to determine at least one area of application of the contact assembly on the predetermined body portion.

In at least one embodiment, the contact assembly comprises at least one massage element movable on the housing into aligned relation with the predetermined body portion corresponding to said one area of engagement.

Furthermore, in at least one embodiment, the drive assembly comprises an on-mode and an off-mode. The sensor assembly may also be structured to activate the drive assembly into the on-mode upon a determination thereby of the area of engagement. Additionally or alternatively, the sensor assembly may be structured to activate the drive assembly into the off-mode upon a determination thereby of an absence of engagement between the user's body and the housing.

In at least one embodiment, the sensor assembly comprises a plurality of sensors collectively disposed relative to the exposed portion to determine an occurrence of a plurality of areas of engagement between said exposed portion and the user's body. The plurality of sensors may further be individually structured and collectively disposed to detect a plurality of areas of engagement occurring at different locations over at least said majority of said exposed portion.

Further, in at least one embodiment a plurality of sensors are cooperatively structured to activate the drive assembly into an on-mode upon a determination by said sensor assembly of an occurrence of a predetermined number of said areas of engagement, such as but not limited to one, two or three.

The massage assembly may also comprise a processor and memory for storage and execution of predetermined massage routines.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a perspective view of an embodiment of a massage assembly and a user in operative engagement therewith.

FIG. 2 is a cross sectional view of the embodiment of FIG. 1 depicting the sensor assembly and other operative components.

FIG. 3 is a cross sectional view of the embodiment of FIG. 1 depicting the drive assembly thereof and other operative components.

FIG. 4 is a perspective wire-frame view partial cutaway of the embodiment of FIG. 1 and a user in operative engagement therewith.

FIG. 5 is a schematic view of the embodiment of FIG. 1 illustrating various operative components thereof.

Like reference numerals refer to like parts throughout the several views of the drawings.

### DETAILED DESCRIPTION OF THE PREFERRED EMBODIMENT

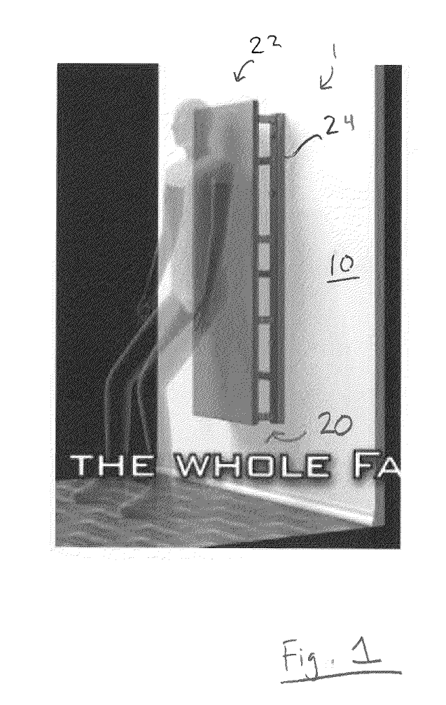

The present invention relates to a massage assembly, generally as is indicated at 1 in FIG. 1. A preferred embodiment of the massage assembly 1 is structured to be mounted to a vertical supporting surface 10, such as a wall, for operative use by a user of the massage assembly 1.

The massage assembly may further comprise a mounting structure 24. The mounting structure 24 facilitates the attachment of the housing 20 to the vertical supporting surface 10. The mounting structure 24 may be disposed between the vertical supporting surface 10 and the rest of the elongated housing 20. The mounting structure 24 may be attached to the vertical supporting surface 10 by any sufficient means of attachment suitable for support of the massage assembly 1, such as screws, bolts, nails, adhesives, etc. In addition, an embodiment of the mounting structure 24 may comprise hardware facilitating disposition of the mounting structure 24, and by extension the massage assembly 1, in a substantially vertical orientation, such as a level. At least one exemplary embodiment of the present invention may comprise a mounting structure 24 appropriately dimensioned and configured for mounting on standard 16-inch center-to-center wall studs.

The massage assembly 1 in at least one embodiment comprises an elongated housing 20 mounted to the supporting surface in a substantially vertical orientation, as shown in FIG. 1. Thus, the orientation of the elongated housing 20 in the substantially vertical orientation facilitates operative use of the massage assembly 1 by a user while the user is in a primarily vertically oriented position. The user's primarily vertically oriented position may comprise the user leaning against the massage assembly. Accordingly, as will be further described herein, the present invention may facilitate improvement of posture of the user.

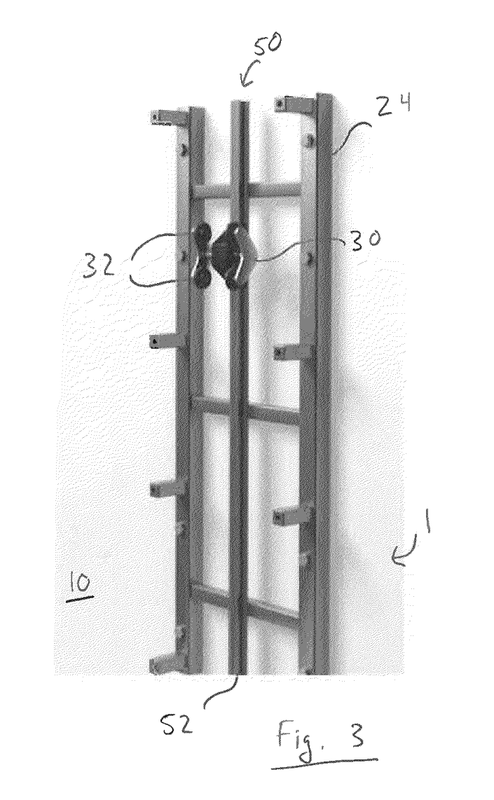

With primary reference to FIG. 3, the massage assembly 1 in at least one embodiment comprises at least one contact assembly 30 movably disposed on the elongated housing 20. The contact assembly 30 operates to apply a massaging pressure to a predetermined body portion of the user. The contact assembly 30 may be movable for example by way of a drive assembly 50, as is discussed below. In at least one embodiment, the contact assembly 50 comprises at least one massage element 32 movable on the housing 20. The massage element 32 is operative to apply a massaging pressure to the user, such as but not limited to kneading, rolling, tapping, vibration, other suitable massage pressures, and/or any other suitable combination or sequence of the foregoing. It should be further appreciated that additional embodiments of the massage assembly 1 may comprise a plurality of contact assemblies 30, each of which may be disposed in relation to a corresponding portion of the user's body for delivery of a massage pressure thereto.

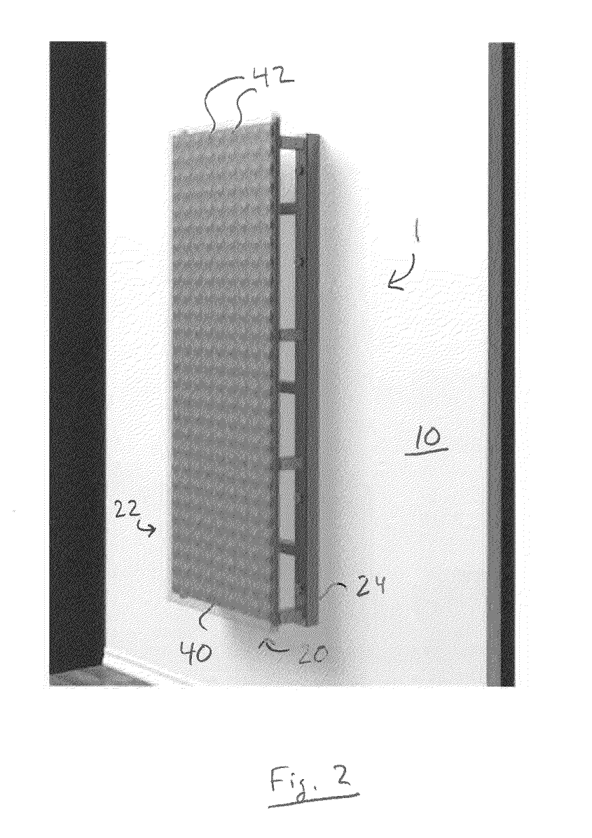

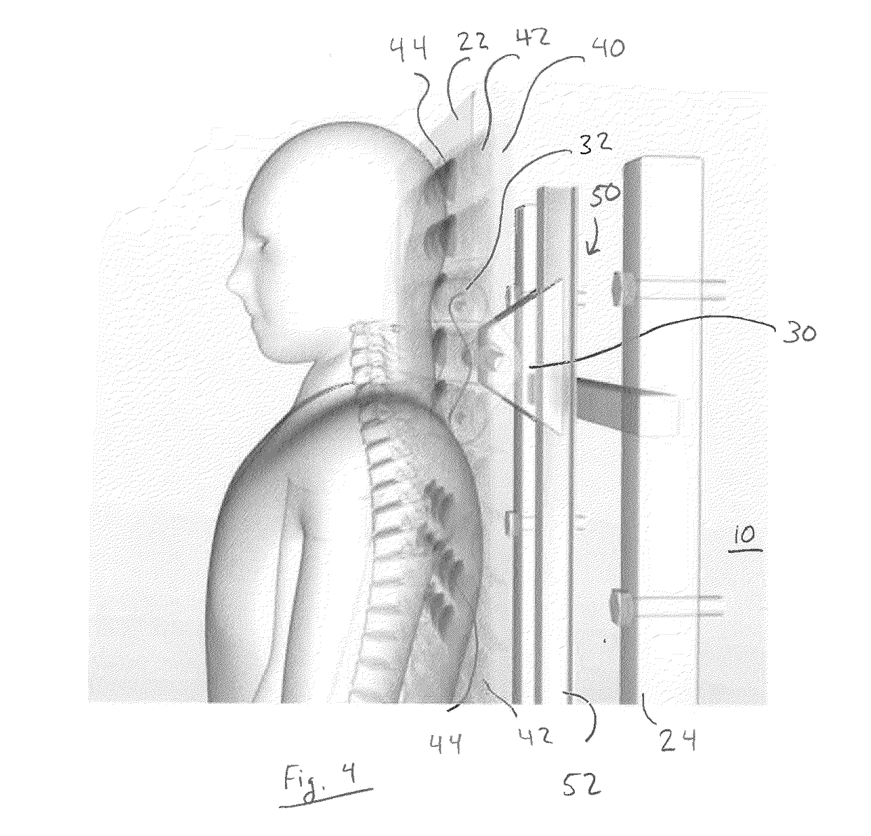

Turning now to FIGS. 2 and 4, at least one embodiment of the massage assembly 1 comprises a sensor assembly 40. The sensor assembly facilitates the determination and/or detection of an area of engagement, indicated as 44 in FIG. 4. The area of engagement 44 as detected by the sensor assembly 40 correlates to an area of the housing 20 to which the user's body is applying pressure, as depicted in FIG. 4. In at least one embodiment, the user may engage the area of engagement 44 by leaning against the housing 20. Detection of the area of engagement 44 by the sensor assembly 40 may be accomplished in at least one embodiment by at least one sensor 42, or preferably a plurality of sensors 42 collectively disposed on the housing 20. The sensors 42 may be infrared sensors, pressure sensitive sensors, and/or any other suitable sensor for detection of engagement of the user's body with the housing 40. With primary reference to FIG. 2, a plurality of sensors 42 may be disposed in a substantially aligned relation, such as a grid formation, with at least a majority of the exposed portion 22 of the housing 20.

Furthermore, in at least one embodiment, the massage assembly 1 detects a plurality of areas of engagement 44. Accordingly, a plurality of sensors 42 may be individually structured and collectively disposed to detect each area of engagement 44. Each area of engagement 44 may correspond to a different portion of the user's body, such as but not limited to the head, shoulders, and “sacrum” i.e. pelvic/lower back area.

With reference to FIGS. 3 and 4, the massage assembly 1 may further comprise a drive assembly 50. The drive assembly 50 movably disposes the contact assembly 30 into a disposition relative to the predetermined body portion of the user. The drive assembly 50 may similarly movably dispose a plurality of contact assemblies 30 into disposition with corresponding portions of the user's body in such embodiments that include a plurality of contact assemblies 30. The drive assembly 50 may comprise an electric motor, a drive track 52, and/or other structure. Accordingly, the contact assembly 30 is movable in relation to the remainder of the housing 20 by way of the drive assembly 50. The drive assembly 50 may also comprise an on-mode and off-mode. The method of activation of the drive assembly 50 in the on and off modes may be determined, for example, in accordance with the user's engagement of the areas of engagement 44, as is discussed in detail below. During the on-mode, the drive assembly 50 facilitates movement of the contact assembly 30 until activated in the off-mode.

With primary reference to FIG. 4, in at least one embodiment, the sensor assembly 40 is engaged in driving relation to the drive assembly 50. Accordingly, the sensor assembly 40 facilitates disposition of the contact assembly 30 into engaging relation with the area of engagement 44 by way of the drive assembly 50. When an area of engagement 44 is detected by the sensor assembly 40, as described above, the sensor assembly 40 activates the drive assembly 50 to dispose the contact assembly 30 into the proper location relative to the area of engagement 44. Thus, the engagement of a user with a portion of the housing 20 is detected by the sensor assembly 40, and the contact assembly 30 is appropriately disposed to deliver a massage to that portion of the user engaged with the housing 20.

In alternative embodiments, the massage assembly 1 may require that more than one area of engagement 44 be detected by the sensor assembly 40 before activation of the drive assembly 50 and/or the contact assembly 30 is achieved. For example, the massage assembly 1 may require that two, three or more areas of engagement 44 be detected. Thus, the massage assembly 1 may facilitate proper posture by requiring that a user engage the housing 20 with multiple portions of the body, such as the head, shoulders and/or sacrum in order to activate the drive assembly 50 and/or contact assembly 30, thereby receiving a massage. Accordingly, until the requisite number of areas of engagement 44 are detected by the sensor assembly 40, whether such number is one, two three, etc., the drive assembly 50 remains in off-mode. Upon detection of the requisite number of areas of engagement 44, the drive assembly 50 is activated in the on-mode. When the detected number of areas of engagement 44 is less than the requisite number of areas of engagement 44 required for delivery of a massage, the drive assembly 50 is activated in the off-mode. This may occur when, for example, the user removes a portion of the body from engagement with the housing 20.

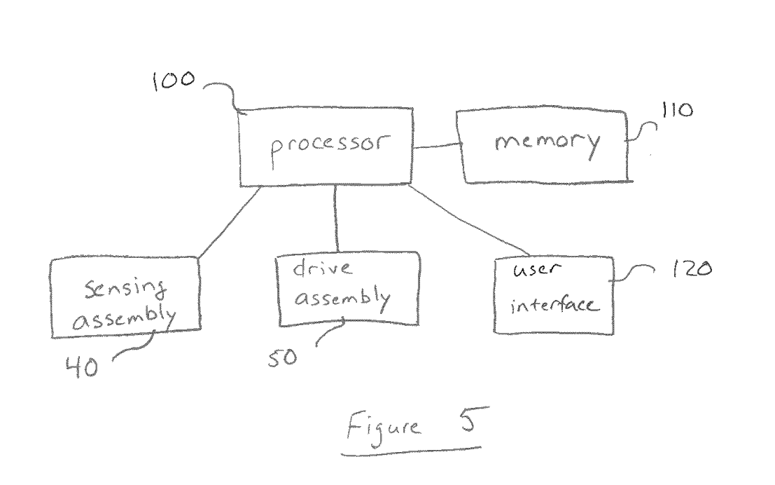

With reference now to FIG. 5, at least one embodiment of the massage assembly 1 comprises a processor 100 and memory 110. The processor 110 may be any suitable microprocessor, microcontroller, etc. capable of carrying out programming instructions in any suitable programming language. The memory 110 may be any suitable form of memory storage device, and is suitable at least for maintenance of at least one, though preferably a plurality, of massage routines. A massage routine is a sequence of massage pressures delivered to predetermined portions of the user's body. Predetermined portions may, in at least one embodiment, correspond to the areas of engagement 44 detected by the sensor array 40. The processor 100 is suitably structured to load the massage routine from the memory 110. Further, the processor 100 may activate the drive assembly 50 and thereby facilitate disposition of the contact assembly 30 into a disposition relative to an area of engagement 44, such as in the process of carrying out a massage routine. Additionally, the processor 100 may respond to the sensor assembly 40, and in response to a signal or signals received therefrom the processor 100 may activate the drive assembly 50.

In at least one embodiment, the massage assembly 1 may also comprise a user interface 120. The user interface 120 allows for user interaction with the massage assembly 1. Specifically, the user interface 120 in at least one embodiment allows activation by the user of at least one of the massage routines stored in memory 110. The user interface 120 is in communication with the processor 100 and allows at least user selection of a predetermined massage routine, and upon selection causes the processor 100 to load the massage routine from memory 110 and execute the massage routine. Execution of the massage routine, as is discussed above, includes the processor 100 controlling the drive assembly 50 and by extension the contact assembly 30 for delivery of a massage to the user.

Examples of massages that may be suitable with various embodiments of the present invention are also provided herein. Such exercises may include neck retractions, whereby a plurality of retractions of the neck from engagement with the housing 20 activates the contact assembly 30 to provide a massage to the user's neck. Performance of a plurality of pelvic tilt exercises may activate a lumbar spine and/or gluteus massage. Performance of a plurality of shoulder retractions may activate a rhomboid and thoracic para-spinal massage. Performance of a plurality of cervical lateral flexion exercises, bringing the user's ear to the shoulder, activates an opposite side upper trapezius massage. Performance of a plurality of bilateral arm raises while pressing the head into the cushion and performing bilateral arm side-raises activates a thoracic muscle massage. Performance of a plurality of one-sided arm raises activates an opposite side specific para-spinal massage. Further, sequences of exercises, such as a neck retraction, shoulder retraction and pelvic tilt sequence, may activate a full body massage.

In addition, an embodiment of the massage assembly 1 may be configured for determination of the weight of a user, and accordingly the intensity of the massage delivered by the contact assembly 30, such as the depth of the vibration and the massage element or elements 32, may be adjusted accordingly.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A massage assembly structured to be mounted on a vertical supporting surface during a massaging procedure, said massage assembly comprising:
an elongated housing mounted on the supporting surface in a substantially vertical orientation,
a contact assembly movably disposed on said housing and operative to apply a massaging pressure to predetermined body portions of the user,
a sensor assembly disposed and structured to determine at least one area of engagement between said housing and the user's body, and
a drive assembly connected in driving relation to said contact assembly; said sensor assembly connected to said drive assembly and operative to determine at least one area of application of said contact assembly on the predetermined body portion.

2. A massage assembly as recited in claim 1 wherein said contact assembly comprises at least one massage element movable on said housing into aligned relation with the predetermined body portion corresponding to said one area of engagement.

3. A massage assembly as recited in claim 1 wherein said drive assembly comprises an on-mode and an off-mode; said sensor assembly structured to activate said drive assembly into said on-mode upon a determination thereby of said one area of engagement.

4. A massage assembly as recited in claim 3 wherein said sensor assembly is structured to activate said drive assembly into said off-mode upon a determination thereby of an absence of engagement between the user's body and said housing.

5. A massage assembly as recited in claim 1 wherein said housing includes an exposed portion disposed and structured to engage the predetermined body portion during the massaging procedure; said sensor assembly disposed relative to said exposed portion to determine said at least one area of engagement.

6. A massage assembly as recited in claim 5 wherein said exposed portion extends along at least a majority of the length of said housing.

7. A massage assembly as recited in claim 6 wherein said housing and said exposed portion are disposed on the supporting surface and cooperatively dimensioned to engage at least a majority of a rear torso portion of the user's body.

8. A massage assembly as recited in claim 5 wherein said sensor assembly comprises a plurality of sensors collectively disposed relative to said exposed portion to determine an occurrence of a plurality of areas of engagement between said exposed portion and the user's body.

9. A massage assembly as recited in claim 8 wherein said plurality of sensors are mounted on said housing; said plurality of sensors collectively disposed in substantially aligned relation with at least a majority of said exposed portion.

10. A massage assembly as recited in claim 9 wherein said plurality of sensors are individually structured and collectively disposed of to detect each of said plurality of areas of engagement occurring at different locations over at least said majority of said exposed portion.

11. A massage assembly as recited in claim 1 wherein said sensor assembly comprises a plurality of sensors collectively disposed on said housing to determine an occurrence of a plurality of areas of engagement between said housing and the user's body.

12. A massage assembly as recited in claim 11 wherein said plurality of sensors are individually structured and collectively disposed to detect each of said plurality of areas of engagement occurring at different locations over at least said majority of said exposed portion.

13. A massage assembly as recited in claim 11 wherein said plurality of sensors are cooperatively structured to activate said drive assembly into an on-mode upon a determination by said sensor assembly of an occurrence of a predetermined number of said areas of engagement.

14. A massage assembly as recited in claim 13 wherein said occurrence of said predetermined number of areas of engagement comprises at least one.

15. A massage assembly as recited in claim 13 wherein said occurrence of said predetermined number of areas of engagement comprises at least two.

16. A massage assembly as recited in claim 13 wherein said occurrence of said predetermined number of areas of engagement comprises at least three.

17. A massage assembly as recited in claim 1 further comprising a processor including memory capabilities, said processor responsively connected to said sensor assembly and connected in activating relation to said drive assembly.

18. The massage assembly as recited in claim 17 wherein said drive assembly is operative to activate said contact assembly to apply said massaging pressure to predetermined body portions upon substantially concurrent activation of said drive assembly by said processor and determinative of said one area of engagement by said sensor assembly.

19. A massage assembly as recited in claim 17 wherein said memory capabilities are configured to store a plurality of massage routines; each of said massage routines configured to apply said massage pressure, by said contact assembly, to predetermined body portions.

20. A massage assembly as recited in claim 19 further comprising a user interface connected to said processor and structured to activate said processor into at least a predetermined one of said massage routines.

21. A massage assembly structured to be mounted on a vertical supporting surface during a massaging procedure, said massage assembly comprising:
an elongated housing mounted on the supporting surface in a substantially vertical orientation,
said housing including an exposed portion disposed and structured to engage the predetermined body portion during the massaging procedure,
a sensor assembly comprising a plurality of sensors collectively disposed on said housing to determine an occurrence of a plurality of areas of engagement between said housing and the user's body,
a contact assembly movably disposed on said housing and operative to apply a massage pressure to predetermined body portions of the user,
a drive assembly connected in driving relation to said contact assembly; said sensor assembly connected to said drive assembly and operative to determine at least one area of application of said contact assembly on the predetermined body portion, and
said at least one area of application at least partially dependent on areas of engagement between said exposed portion and the user's body.

22. A massage assembly as recited in claim 21 further comprising a processor and memory in communication therewith, said processor responsively connected to said sensor assembly and connected in activating relation to said drive assembly.

23. A massage assembly as recited in claim 22 wherein said memory is configured to maintain a plurality of massage routines therein; each of said massage routines configured to apply said massage pressure, by said contact assembly, to predetermined body portions.
